(19) United States
(12) Patent Application Publication
(10) Pub. No.: US 2008/0144114 A1
(43) Pub. Date: Jun. 19, 2008

(54) Method and system for dynamic printer profiling

(75) Inventors: Geoffrey J. Woolfe, Canandaigua, NY (US); Martin S. Maltz, Rochester, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/640,561

(22) Filed: Dec. 18, 2006

(51) Int. Cl. G06K 15/00

(52) U.S. Cl. 358/3.24; 358/3.23

(57) ABSTRACT

This presently described embodiment deals with this problem by dynamically constructing color management device profiles that are optimized for accurate reproduction of a particular document. This apparatus utilizes three components. Device characterization data describes the relationship between device drive values (e.g., CMYK in the case of a 4 color printer) and the resulting color (spectral, CIELab, CIEXYZ or similar). Critical document colors are the critical colors in a document that is to be output on the device. The colors will generally be described by their CIELab, CIEXYZ or similar coordinates, but may also include color tolerances and frequency of occurrence values. Device modeling algorithms are mathematical procedures that allow the construction of device-to-color and color-to-device models in a way that different accuracy weightings can be applied in different regions of color space. These components function together to build a device profile in which the errors in the critical document colors are minimized.

### BACKGROUND

Color management has traditionally operated on output devices using ICC destination profiles or their functional equivalent. In such a system, the output device is typically brought into a state of process control using a procedure called calibration. Next, the color behavior of the device is typically modeled in a process called device characterization. The output of the characterization process is the device profile or its functional equivalent. In the characterization process, a digital characterization target, defined in terms of device code values, is sent to the device and the resulting color output is measured. This color output is typically described using a device independent color space such as CIELab, CIEXYZ or another calorimetric space derived from these. The color output measurements together with the device code values defined in a characterization target are used to construct two mathematical models—a color (CIELab, CIEXYZ, etc.) to device (CMYK, RGB, etc.) model and a device to color model. These models are then packaged in a suitable file format to create the device profile or its functional equivalent.

One problem with this approach is that the modeling process does not perfectly describe the behavior of the device and, hence, there are errors. The magnitude of these errors varies from location to location within the color space. Most color management profile builders generally design their device modeling algorithms to minimize the errors for important colors such as the white point, neutral colors and certain memory colors. Unfortunately, the decision on how to partition errors across the color space is made at the time the profile is constructed and, hence, is not optimized for any specific document. It is possible, therefore, for a document to contain a strong representation of colors in locations where there are significant errors in the device models. Such documents will be very difficult to print accurately and/or satisfactorily.

The market has recently seen a new generation color management system in which the system maintains device characterization data, rather than device profiles or their equivalent. In such systems, the device model can be built dynamically at the time it is required. However, this system does not take into account the critical colors of the document to be rendered.

The presently described embodiments overcome these difficulties and others by implementing a method and system by which such dynamic model creation uses color information from a document to build a profile that provides optimal color accuracy for that particular document.

### BRIEF DESCRIPTION

In one aspect of the presently described embodiments, the method comprises generating device characterization data for the image rendering device, determining critical document colors for a document to be rendered by the image rendering device, and, developing device modeling routines based on the determined critical document colors and the characterization data, whereby color errors are minimized in regions of the critical document colors.

In another aspect of the presently described embodiments, the generating of characterization data comprises calibrating the image rendering device, printing a characterization target by the image rendering device, measuring the output target, and, storing the measured data.

In another aspect of the presently described embodiments, the determining of critical document colors comprises determining colors in the document, extracting at least one of images and graphic elements from the document, computing colorimetric specifications for each color in the at least one image and/or graphic element, performing a cluster analysis, assigning colors to clusters determined in the cluster analysis, and, outputting a list of coordinates for critical document colors based on the assignment of colors.

In another aspect of the presently described embodiments, the developing of modeling routines comprises generating device-to-color models, and, generating color-to-device models.

In another aspect of the presently described embodiments, the generating of the device-to-color models comprises increasing error weights of color in regions of critical document colors.

In another aspect of the presently described embodiments, the generating of the device-to-color models comprises increasing sampling based on the characterization data of the critical document colors.

In another aspect of the presently described embodiments, the generating of device-to-color models comprises increasing weights of color based on proximity to critical document colors and tolerance required for reproduction of the color.

In another aspect of the presently described embodiments, the generating of device-to-color models comprises weighting color based on proximity to a critical document color and frequency of occurrence of that color.

In another aspect of the presently described embodiments, the generating of color-to-device models comprises selectively decreasing distance between color nodes in a multi-dimensional lookup table.

In another aspect of the presently described embodiments, the generating of color-to-device models comprises selectively adjusting node values in a multi-dimensional lookup table.

In another aspect of the presently described embodiments, a rendering system comprises a color sampler operative to determine critical document colors for a document to be rendered by the system, and, a controller operative to generate device characterization data for the system and develop device modeling routines based on the critical document colors and the characterization data, whereby color errors are minimized in regions of the critical document colors.

In another aspect of the presently described embodiments, the controller is operative to calibrate the image rendering device, initiate printing of a characterization target, and store data relating to a measurement of the printed target.

In another aspect of the presently described embodiments, the color sampler is operative to determine colors in the document, extract at least one of images and graphic elements from the document, compute colorimetric specifications for each color in the at least one image and/or graphic element, perform a cluster analysis, assign colors to clusters determined in the cluster analysis and output a list of coordinates for critical document colors based on the assignment of colors.

In another aspect of the presently described embodiments, the controller is operative to generate device-to-color models and generate color-to-device models.

In another aspect of the presently described embodiments, the device-to-color models comprise increased error weights of color in regions of critical document colors.

In another aspect of the presently described embodiments, the device-to-color models comprise increased sampling based on the characterization data of the critical document colors.

In another aspect of the presently described embodiments, the device-to-color models comprise increased weights of color based on proximity to critical document colors and tolerance required for reproduction of the color.

In another aspect of the presently described embodiments, the generating of device-to-color models comprise weighted color based on proximity to a critical document color and frequency of occurrence of that color.

In another aspect of the presently described embodiments, the color-to-device models comprise selectively decreased distance between color nodes in a multi-dimensional lookup table.

In another aspect of the presently described embodiments, the color-to-device models comprise selectively adjusted node values in a multidimensional lookup table.

### BRIEF DESCRIPTION OF THE DRAWINGS

FIG. 1 is an illustration of a system into which the presently described embodiments may be incorporated;

FIG. 2 is a flow chart illustrating a method according to the presently described embodiments;

FIG. 3 is a flow chart illustrating a method according to the presently described embodiments;

FIG. 4 is a flow chart illustrating a method according to the presently described embodiments; and,

FIG. 5 is a flow chart illustrating a method according to the presently described embodiments.

### DETAILED DESCRIPTION

The presently described embodiments are directed to a system and method to dynamically construct color management device profiles that are improved, e.g. optimized, for accurate reproduction of a particular document by an image rendering device (e.g., a printer such as a xerographic printer). The presently described embodiments make use of several components that function together to create the profile. These components include:

1. DEVICE CHARACTERIZATION DATA. This is one or more sets of data that describe the relationship between device drive values (e.g., CMYK in the case of a 4-color printer) and the color (spectral, CIELab, CIEXYZ or similar) produced by those drive values.

2. CRITICAL DOCUMENT COLORS. This is a set of data specific to a document that is to be output on the image rendering device. It comprises, in one form, a list of colors that are considered critical for accurate color reproduction of the document. The colors will generally be described by the CIELab, CIEXYZ or similar coordinates but may also include color tolerances (possibly expressed as ΔE* or similar values) and frequency of occurrence (number of pixels, area coverage or similar) values.

3. DEVICE MODELING ALGORITHMS. These are mathematical procedures that allow the construction of device-to-color and color-to-device models in a way that allows for different accuracy and/or error weightings to be applied in different regions of color space.

According to the presently described embodiments, these components function together to build a device profile in which the color errors are minimized in the color regions specified by the critical document colors component.

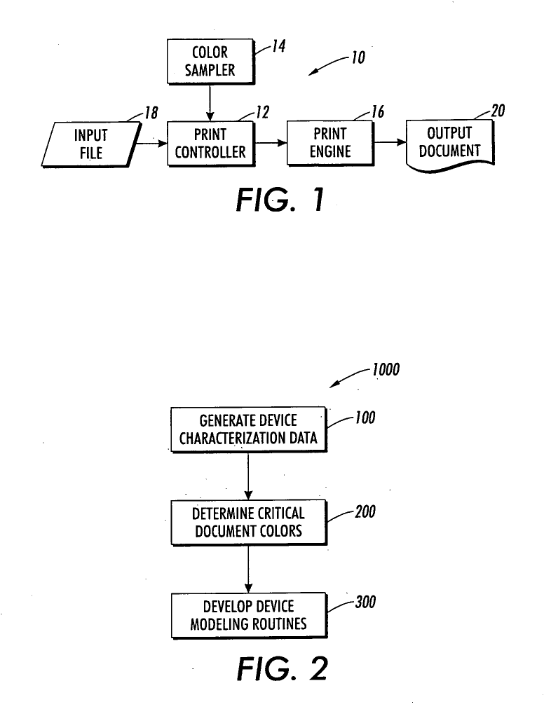

With reference to FIG. 1, a system 10 into which the presently described embodiments may be incorporated is illustrated. More specifically, a system 10 includes a print controller 12 and a color sampler 14. The print controller 12 is in communication with a print engine 16. It should also be appreciated that input files 18 are provided to the system which produces output documents 20.

Implementation of the presently described embodiments in the system 10 is described in greater detail in connection with FIGS. 2-5. Nonetheless, it should be understood that, in at least one form, selected routines reside in color sampler 14 while other routines reside in printer controller 12. The software routines for implementing the presently described embodiments may also be stored in a centralized location within the system, such as the print controller 12 or the color sampler 14. Alternatively, the routines implementing the presently described embodiments may be distributed among any of the elements of FIG. 1 or other elements that are not specifically shown in FIG. 1.

It will be understood that the presently described embodiments are merely exemplary in nature. The presently described embodiments may be implemented using a variety of different hardware configurations and/or software techniques to accomplish objectives thereof.

Referring now to FIG. 2, a method 1000 according to the presently described embodiments is illustrated in a flow chart form. The method 1000 includes generating device characterization data (at 100). This is, in one form, accomplished by the printer controller 12. Next, critical document colors are determined (at 200). In one form, this is accomplished by the color sampler 14. Last, device modeling algorithms are developed based on the characterization data and the critical document colors (at 300). This is, in one form, accomplished by the print controller 12.

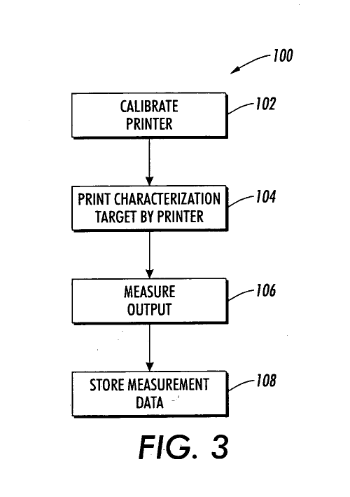

Referring now to FIG. 3, as noted above, implementing the presently described embodiments includes generating the device characterization data. This data may be obtained in the same or similar way that device characterization data is obtained in the known systems of color management. A method 100 is illustrated as an example.

First, in the method 100, the device is brought into a state of process control by performing a calibration (at 102). Then, a device characterization target (defined in terms of device drive values, such as CMYK) is sent directly to the printer, with all color management turned off, and printed (at 104). The printed output of this target is measured, in one form, with a spectrophotometer (at 106). The data (e.g., device characterization data or measurement data) is then stored in a suitable file in the device or its controller (at 108).

The device characterization data can be likened to a pair of linked arrays. The first array contains the device drive values (CMYK) and the second array contains the color produced. The color could be stored as spectral data or as calorimetric data. If it is stored as calorimetric data, then there is an inherent assumption of the intended observer and the intended viewing illuminant, but, if it is stored as spectral data, then these variables could be set at the time of printing. This could provide additional flexibility at the expense of a more complex user interface.

The device characterization data could be created and installed during the manufacturing process for the device or it could be generated in the field. In any case, it is data that seldom needs to be refreshed or recreated as long as the device is maintained in a state of process control.

The device characterization data can also contain much more data than is actually required by the device modeling algorithms. In fact, the device space could be very finely sampled by the characterization target and stored in the device characterization data. At the time of profile creation, the device modeling algorithms might only use a modest subset of the available device characterization data.

Another function of the presently described embodiments is to generate the critical document colors. The critical document colors are determined by an element such as the color sampler 14. The function of the color sampler 14 is to determine the important or significant colors in the document. The definition of what constitutes an “important or significant color” could be selectable, by the customer, from a range of options. There could also be a default setting that worked for most users and documents. Another option would be for the customer to select what is considered to be the important or significant colors by clicking a mouse on the appropriate parts of a softcopy rendition of the document.

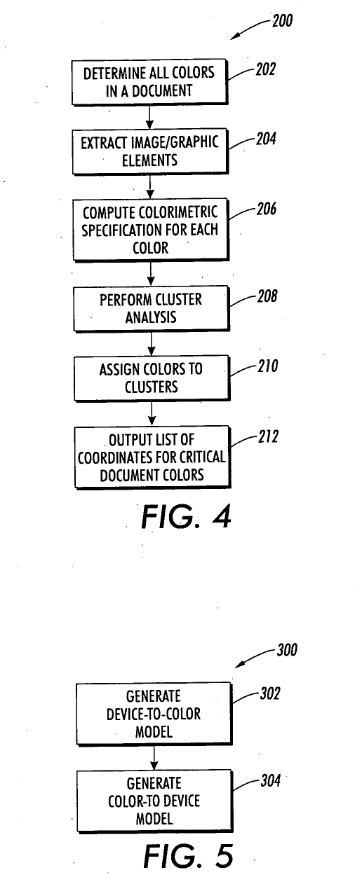

Referring now to FIG. 4, in one form, a method 200 by which the color sampler 14 may extract the important or significant colors in a document includes:

1. Determining some or all the named colors or spot colors in the document (at 202).

2. Extracting the image and graphic elements from the document (at 204).

3. Using the defined color encoding of each image and graphic to compute the calorimetric specification (in a device independent color space such as CIEXYZ or CIELab) of the colors defined in the image or graphic (at 206). If the number of pixels is sufficiently large that excessive computation times would be necessary, then sub-sampling of these elements could be performed.

4. Performing a cluster analysis of the colors determined at 206 (at 208). In this regard, each of the colors is assigned to a cluster. The cluster is represented prototypically by a single color at the centroid of all colors assigned to the cluster. Ideally, the required number of clusters should be determined algorithmically based on a maximum cluster size (perhaps specified as a ΔE*) or similar limit from the cluster prototype (centroid) to the furthest color assigned to the cluster. There may also be an upper limit imposed on the number of colors assigned to a cluster or to the sum of distances from the cluster centroid to all members of the cluster to ensure a suitably dense sampling of regions of color space in which large numbers of document colors fall.

5. Assigning the colors to a cluster (at 210). The color sampler may be configured to assign every color in the document to a cluster or to ignore infrequent, isolated (in color space) colors that have little importance in the document. Alternatively, the color sampler may be configured to sample more densely in regions of color space that are deemed to be important. Such regions might include the human memory colors such as flesh colors, foliage colors and sky colors.

6. Outputting by the color sampler of a list of the color coordinates for the critical colors in the document (at 212). This output represents the critical document colors.

Referring now to FIG. 5, as noted above, the presently described embodiments use the device characterization data (obtained in FIG. 3) and the critical document colors (obtained in FIG. 4) to generate device modeling algorithms or routines using a method 300. A first such algorithm or routine creates a device-to-color model that describes the color produced by the device as a function of its drive parameters (at 302). Some of these algorithms work by assuming a specific functional form for the device model and then optimizing the parameters of that model's functional form to minimize the average error. Other approaches could exactly fit all the device characterization data, but conduct localized smoothing as an attempt to average out noise in the measurements. Either type of algorithm or routine can be configured to minimize the weighted errors as a function of their location in the color space. The presently described embodiments, in at least one form, use the critical document colors data to establish these error weights. This could be done in a number of ways including:

1. If the critical document colors are simply a list of color coordinates, then the weights would be increased in regions centered on these coordinates and the weight would gradually decrease with increasing color distance from each critical color coordinate.

2. If the critical document colors are simply a list of color coordinates, then data to build the device characterization models could be sampled from the device characterization data in such a way that more patches are sampled in the vicinity of the critical colors with the sampling becoming sparser with increasing color distance from each critical color coordinate.

3. If the critical document colors contain both color location coordinates and color tolerances, then the weighting could be based on both the proximity to a critical color and the tolerance required in the reproduction of that color. As tolerances become narrower, the error weighting would increase.

If the critical document colors contains both color location coordinates and frequency of occurrence data, then the weighting could be based on both the proximity to a critical color and the frequency of occurrence of that color. As frequency of occurrence increases, the error weighting would increase.

The device modeling algorithms also invert the device-to-color model to generate a color-to-device model (at 304). Although in principle, this can be done in a way that introduces no additional error, practical inversion involves interpolation techniques that also have an associated error. Once again, the critical document colors can be used to ensure that the model inversion errors are smallest in the regions of the critical document colors. For example:

1. The previously discussed techniques can be applied to the interpolation techniques.

2. More specifically, the color-to-device model is often represented as a multi-dimensional lookup table, and node spacing can be made closer for the critical document colors.

3. The node values in the multi-dimensional lookup table can be adjusted so that interpolation gives the desired results for the critical document colors.

An advantage provided by the presently described embodiments is the creation of an optimized destination or output profile that maximizes the color reproduction accuracy for the critical colors of any document. This can be of particular importance for trademark colors, important memory colors or the colors of uniforms, flags and other symbols. Increased color reproduction accuracy will improve customer satisfaction and should reduce time spent making color adjustments in pre-press.

Another advantage is that this concept fits easily within the color management infrastructure being provided by the other color management system providers.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for profiling an image rendering device, the method comprising:
generating device characterization data for the image rendering device;
determining critical document colors for a document to be rendered by the image rendering device; and,
developing device modeling routine based on the determined critical document colors and the characterization data, whereby color errors are minimized in regions of the critical document colors.

2. The method as set forth in claim 1 wherein the generating of characterization data comprises:
calibrating the image rendering device;
printing a characterization target by the image rendering device;
measuring the output target; and,
storing the measured data.

3. The method as set forth in claim 1 wherein the determining of critical document colors comprises:
determining colors in the document;
extracting at least one of images and graphic elements from the document;
computing calorimetric specifications for each color in the at least one image and/or graphic element;
performing a cluster analysis;
assigning colors to clusters determined in the cluster analysis; and,
outputting a list of coordinates for critical document colors based on the assignment of colors.

4. The method as set forth in claim 1 wherein the developing of modeling routines comprises:
generating device-to-color models; and,
generating color-to-device models.

5. The method as set forth in claim 4 wherein the generating of the device-to-color models comprises increasing error weights of color in regions of critical document colors.

6. The method as set forth in claim 4 wherein the generating of the device-to-color models comprises increasing sampling based on the characterization data of the critical document colors.

7. The method as set forth in claim 4 wherein the generating of device-to-color models comprises increasing weights of color based on proximity to critical document colors and tolerance required for reproduction of the color.

8. The method as set forth in claim 4 wherein the generating of device-to-color models comprises weighting color based on proximity to a critical document color and frequency of occurrence of that color.

9. The method as set forth in claim 4 wherein the generating of color-to-device models comprises selectively decreasing distance between color nodes in a multi-dimensional lookup table.

10. The method as set forth in claim 4 wherein the generating of color-to-device models comprises selectively adjusting node values in a multi-dimensional lookup table.

11. A rendering system comprising:
a color sampler operative to determine critical document colors for a document to be rendered by the system; and,
a controller operative to generate device characterization data for the system and develop device modeling routines based on the critical document colors and the characterization data,
whereby color errors are minimized in regions of the critical document colors.

12. The system as set forth in claim 11 wherein the controller is operative to calibrate the image rendering device, initiate printing of a characterization target, and store data relating to a measurement of the printed target.

13. The system as set forth in claim 11 wherein the color sampler is operative to determine colors in the document, extract at least one of images and graphic elements from the document, compute calorimetric specifications for each color in the at least one image and/or graphic element, perform a cluster analysis, assign colors to clusters determined in the cluster analysis and output a list of coordinates for critical document colors based on the assignment of colors.

14. The system as set forth in claim 11 wherein the controller is operative to generate device-to-color models and generate color-to-device models.

15. The system as set forth in claim 14 wherein the device-to-color models comprise increased error weights of color in regions of critical document colors.

16. The system as set forth in claim 14 wherein the device-to-color models comprise increased sampling based on the characterization data of the critical document colors.

17. The system as set forth in claim 14 wherein the device-to-color models comprise increased weights of color based on proximity to critical document colors and tolerance required for reproduction of the color.

18. The system as set forth in claim 14 wherein the generating of device-to-color models comprise weighted color based on proximity to a critical document color and frequency of occurrence of that color.

19. The system as set forth in claim 14 wherein the color-to-device models comprise selectively decreased distance between color nodes in a multi-dimensional lookup table.

20. The system as set forth in claim 14 wherein the color-to-device models comprise selectively adjusted node values in a multidimensional lookup table.
